(19) United States
(12) Patent Application Publication
(10) Pub. No.: US 2025/0196454 A1
(43) Pub. Date: Jun. 19, 2025

(54) METHOD OF CONCRETE REPAIR

(71) Applicant: E-CHEM TECHNOLOGIES LTD, Nottingham (GB)

(72) Inventors: Gareth GLASS, Lichfield Staffordshire (GB); Christian STONE, Nottingham (GB)

(73) Assignee: E-CHEM TECHNOLOGIES LTD, Nottingham (GB)

(21) Appl. No.: 18/980,653

(22) Filed: Dec. 13, 2024

(30) Foreign Application Priority Data
Dec. 15, 2023 (GB) 2319332.9

(51) Int. Cl. B29C 73/02; E04G 23/02

(52) U.S. Cl. CPC B29C 73/02; E04G 23/0203

(57) ABSTRACT

A method (100) of concrete repair is disclosed, comprising: forming (102) a cavity (22) in a steel-reinforced concrete structure by removing concrete to expose steel reinforcement (21) and a concrete surface (23) within the cavity; providing (104) an anode assembly; providing (106) an ionically conductive filler (29); arranging (108) the anode assembly and the ionically conductive filler within the cavity and attaching an anode assembly body to the exposed concrete surface, wherein the ionically conductive filler is arranged between the anode assembly body and the exposed concrete surface; using (110) the electron-conducting connector (3) to provide a path for electrons to flow from the anode (1) to the exposed steel reinforcement (21) in the cavity; and filling (112) the cavity with a concrete repair material. The anode assembly body and the ionically conductive filler are arranged apart from the exposed steel reinforcement in order to separate the anode assembly body and the ionically conductive filler from the exposed steel reinforcement by the concrete repair material.

### FIELD OF THE INVENTION

The invention relates to a method of repairing steel-reinforced concrete. In particular, the invention relates to the arrangement of anodes in a concrete repair to protect steel extending from the edge of the repair area into the adjacent sound concrete from further corrosion.

### BACKGROUND

Steel reinforced concrete elements are produced by forming one or more layers of reinforcing steel and casting this steel in concrete. The reinforced concrete element may be a slab, column or beam of a structure. The steel provides the tensile strength and the concrete provides the compressive strength for that element.

Normally steel is passive in concrete because concrete provides a benign alkaline environment for the steel. However localised corrosion can occur when aggressive ions such as chloride ions penetrate through the concrete cover to the steel. The corrosion products are expansive and this results in delamination and spalling of the concrete cover over the corroding steel to form a cavity or pothole.

Repair of this damage involves removing concrete back to a sound concrete surface to expose the corroding steel, removing the corrosion products from the steel and restoring the profile of the concrete with an alkaline patch repair material that provides a benign environment for the steel and resists further ingress of aggressive ions. These are called patch repairs. Removal of the concrete leaves behind a cavity with a rough fractured surface. It is not flat and will have local undulations of 10 mm or more where the aggregate in the concrete either protrudes above the surface or has been removed from the concrete matrix.

Steel in this concrete adjacent to the repair area is particularly vulnerable to corrosion damage in the future. In this situation, galvanic (or “sacrificial”) anode assemblies are sometimes used to prevent further corrosion from starting on this steel. This effectively increases the repaired area. A key component of the anode assembly is a metal element that is more electrochemically active than steel and will therefore corrode in preference to steel when it is connected to steel. This is the “anode” of the anode assembly, also referred to as the assembly anode.

One type of anode assembly is a discrete anode assembly that is tied directly to the exposed reinforcing steel in the patch repair area. These anodes are limited in size by the limited thickness of the cover of the concrete to the reinforcement and the congested reinforcing steel bars. They have to be secured in place to withstand the physical process of placing the repair material to restore the concrete profile. The undulating fracture surface of the cavity also restricts the shape of the anode that can be placed in the repair.

The anode assembly can include an encapsulation material that both maintains anode activity and accommodates any expansive zinc corrosion product. The encapsulation material tends to be a highly conductive matrix to promote the flow of protection current from the metal anode element.

After the anode assembly has been secured in place, a profile restoring repair material is applied to complete the repair. This ionically connects the anode assembly to the sound concrete and resists further ingress of aggressive ions. While it is widely believed that this assembly works well, the inventors of the invention described herein believe it can be substantially improved. In particular, there is a demand for improved protection of sound steel in the area surrounding a patch in a concrete structure repaired using such anode assemblies. This area is known to be vulnerable to corrosion following the repair of the nearby patch. This corrosion vulnerability is known as an incipient anode or a halo effect.

Another type of anode assembly is installed in cavities drilled into the original concrete adjacent to the repair. This overcomes some of the issues of protecting the steel outside the patch repair. However, it involves the forming of another cavity of a suitable size into the sound concrete of the structure to accept the anode and encapsulation material of the assembly.

### SUMMARY OF INVENTION

According to an aspect of the present invention, there is provided a method of repairing corrosion-damaged concrete, comprising; forming a cavity in a steel-reinforced concrete structure by removing concrete to expose steel reinforcement and expose a concrete surface within the cavity; providing an anode assembly, the anode assembly comprising an anode assembly body and an electron-conducting connector, the anode assembly body comprising an anode that is a more electrochemically active metal than the steel reinforcement of the steel-reinforced concrete structure and an encapsulation material adjacent to the anode configured to receive a corrosion product produced by the anode, wherein the electron-conducting connector provides a path for electrons to flow from the anode; providing an ionically conductive filler; arranging the anode assembly and the ionically conductive filler within the cavity and attaching the anode assembly body to the exposed concrete surface, wherein the ionically conductive filler is arranged between the anode assembly body and the exposed concrete surface; using the electron-conducting connector, providing a path for electrons to flow from the anode to the exposed steel reinforcement in the cavity; and filling the cavity with a concrete repair material; wherein: the ionically conductive filler has a greater ionic conductivity than the concrete repair material; and arranging the anode assembly and the ionically conductive filler within the cavity comprises arranging the anode assembly body and the ionically conductive filler apart from the exposed steel reinforcement in order to separate the anode assembly body and the ionically conductive filler from the exposed steel reinforcement by the concrete repair material.

In this way, the sound steel reinforcement of the steel-reinforced concrete structure surrounding the repair area (defined by the cavity) is better protected from subsequent corrosion damage. In practice, when implementing prior solutions, the assembly body can simply be tied directly to the exposed reinforcement using the electron conductor and then an ionically conductive filler may be applied. This means that the anode assembly body will be connected to the steel of the exposed reinforcement through the ionically conductive filler. This has been found to undesirably direct ionic current generated by the anode assembly towards the (previously exposed) steel reinforcement in the repair area. Separating the anode assembly body and the ionically conductive filler from the exposed steel reinforcement so that they are not in contact with the exposed steel avoids protective ionic flow from being diverted away from the surrounding concrete. The ionically conductive filler is more conductive than the concrete repair material and is positioned on the sound concrete that is exposed by the cavity, and does not touch the exposed steel. This encourages ionic flow from the anode assembly towards steel reinforcement covered by sound concrete, and away from the repair area, to better protect the nearby steel from subsequent corrosion. In other words, separating the anode assembly from the exposed steel reinforcement mitigates the incipient anode or halo effect.

This method involves attaching the anode assembly body to the concrete surface exposed by removing concrete to expose steel reinforcement. The cavity will typically be formed by removing substantially only damaged concrete around the steel. This approach also avoids installation of further anode assemblies in surrounding sound concrete by attaching the anode to the exposed undulating surface of the cavity. Such undulation will typically exceed 1 mm, or 2 mm, or 3 mm, or 5 mm, or 10 mm, depending on the size of the aggregate used in the concrete.

This minimises the removal of sound concrete as another cavity of a suitable size into the sound concrete of the structure to accept the anode and encapsulation material of the assembly is not required.

The encapsulation material and the ionically conductive materials are separate materials.

The encapsulation material may be a matrix configured to receive a corrosion product produced by the anode, and is preferably more conductive than the concrete repair material to promote flow of current from the anode.

The encapsulation material preferably at least partially encloses the anode. The encapsulation material may cover at least 20%, preferably at least 40%, more preferably at least 50%, more preferably at least 60%, more preferably at least 70%, more preferably at least 80%, more preferably at least 90%, of the external surface area of the anode. A greater coverage of encapsulating material improves the ability of the encapsulation material to receive a corrosion product of the anode, but it is not essential to fully enclose the anode. Nonetheless, most preferably, the encapsulation material fully encloses the anode, except for a part where the electron-conducting connector extends away from the anode.

The encapsulation material forms part of the anode assembly. In particular, the encapsulation material is joined to the anode, such that the anode and encapsulation material may be arranged in the cavity as a single unit. The encapsulation material preferably contains an electrolyte to facilitate current flow through the encapsulation material. Many known techniques involve the use of a backfill to receive dissolution products. However, the backfill and anode are generally inserted sequentially into a cavity drilled into sound concrete. The use of such separate anode and backfill is difficult to accommodate if the anode is to be attached to part of the exposed undulating surface of a cavity formed by removing damaged concrete.

While the use of an encapsulation material is specified in the present method, it is also foreseen that alternative methods may involve forming a cavity in a steel-reinforced concrete structure by removing concrete to expose steel reinforcement and expose a concrete surface within the cavity; providing an anode assembly, the anode assembly comprising an anode assembly body and an electron-conducting connector, the anode assembly body comprising an anode that is a more electrochemically active metal than the steel reinforcement of the steel-reinforced concrete structure, wherein the electron-conducting connector provides a path for electrons to flow from the anode; providing an ionically conductive filler; arranging the anode assembly and the ionically conductive filler within the cavity and attaching the anode assembly body to the exposed concrete surface, wherein the ionically conductive filler is arranged between the anode assembly body and the exposed concrete surface; using the electron-conducting connector, providing a path for electrons to flow from the anode to the exposed steel reinforcement in the cavity; and filling the cavity with a concrete repair material; wherein: the ionically conductive filler has a greater ionic conductivity than the concrete repair material; and arranging the anode assembly and the ionically conductive filler within the cavity comprises arranging the anode assembly body and the ionically conductive filler apart from the exposed steel reinforcement in order to separate the anode assembly body and the ionically conductive filler from the exposed steel reinforcement by the concrete repair material. Such a method may optionally employ a backfill arranged so as to at least partially encapsulate the anode and configured to receive a corrosion product produced by the anode.

Preferably, the anode assembly further comprises an activator. The activator may be added to the encapsulation material or applied directly to the anode surface.

Preferably, the ionically conductive filler is applied to the exposed concrete surface before the anode assembly body is attached to the exposed concrete surface. The exposed concrete surface is generally rough and comprises undulations of about 10-20 mm in depth due to the concrete's aggregate. Applying the ionically conductive filler first ensures it can be applied thoroughly on the exposed concrete surface for a good conductive connection between the anode assembly body and the concrete. The ionically conductive filler may be applied until it covers and conforms to the exposed concrete surface.

Alternatively, the ionically conductive filler can be applied onto the anode assembly body so that it comes into contact with the exposed concrete surface when the anode assembly is attached to the exposed concrete surface.

Preferably, at least some of the ionically conductive filler is applied initially to the anode assembly body such that it becomes applied to the exposed concrete surface with (i.e. at the same time as) the attachment of the anode assembly body. In this way, good contact between the ionically conductive filler and the anode assembly body can be ensured. Some ionically conductive filler may also be applied directly to the exposed concrete surface to ensure a good conductive connection between the ionically conductive filler and the exposed concrete surface. Alternatively, all of the ionically conductive filler may be applied initially to the anode assembly body.

Preferably, the method comprises providing the ionically conductive filler in a localised manner such that a total area of the exposed concrete surface in contact with the ionically conductive filler is less than twice of a total area of a face of the anode assembly body facing the exposed concrete surface. In this way, unintentional contact between the exposed steel reinforcement and the ionically conductive filler can be avoided. Additionally, efficient use of the ionically conductive filler can be made. Preferably, the ionically conductive filler is applied in a localised manner such that a total area of the exposed concrete surface in contact with the ionically conductive filler is less than 1.2 times the total area of a face of the anode assembly body facing the exposed concrete surface.

Preferably, attaching the anode assembly body comprises attaching the anode assembly body at a peripheral region of the cavity that is shallower than a central region of the cavity with respect to an outer surface of the steel-reinforced concrete structure through which the cavity is formed. In particular, attaching the anode assembly body may comprise attaching the anode assembly body in a region of the cavity where the outermost steel reinforcement is still covered by the exposed concrete surface. In this way, the anode assembly body is positioned as close as possible to the area surrounding the repair area so that the sound steel adjacent the repair area can be protected from subsequent corrosion by the anode assembly.

Preferably, attaching the anode assembly body to the exposed concrete surface comprises attaching the anode assembly body to the exposed concrete surface at a portion of the exposed concrete surface that substantially overlaps two covered steel rebars of the steel-reinforced structure that remain covered by the exposed concrete surface at a position that is equidistant between the two covered steel rebars within a tolerance of 20% of a separation distance between the two covered steel rebars. In this way, the anode assembly body is arranged to optimise the current distribution from the anode assembly between the covered steel rebars, which may be particularly vulnerable to subsequent corrosion.

Preferably, the ionically conductive filler is arranged between the anode assembly body and the exposed concrete surface before the anode assembly body is attached to the exposed concrete surface. However, some embodiments are foreseen in which the ionically conductive filler is added after attachment.

Preferably, attaching the anode assembly body comprises attaching the anode assembly body equidistantly between two steel rebars of the exposed steel reinforcement within a tolerance of 20% of a separation distance between the two steel rebars. This has been found to optimise the distribution of ionic current from the anode assembly.

Preferably, the ionically conductive filler is adhesive. In this way, the ionic filler can assist with the attachment of the anode assembly body to the exposed concrete surface. In one example, the ionically conductive filler can include an adhesive hydrogel. In another example, the ionically conductive filler can include organic polymers to improve adhesion. Examples of adhesive organic polymers include an acrylic latex suspension and polyvinyl acetate.

Preferably the adhesive ionic conductive filler bonds the anode assembly to the concrete surface with a pull-off strength of at least 0.3 psi (0.002 N/mm²). More preferably, the pull-off strength is at least 3 psi. Even more preferably, the pull-off strength of the attachment is at least 30 psi. The pull-off strength of the attachment may be at least 100 psi. The pull-off strength provided by the ionically conductive filler may be at least 0.3 psi, and more preferably at least 3 psi, when initially applied and increase to at least 30 psi, and more preferably at least 100 psi, after setting. This is useful so that the anode assembly body can be attached more easily in repairs of vertical or overhead concrete surfaces.

Preferably, the anode assembly body has a largest dimension of less than 200 mm. In this way, the anode assembly body is sized to fit within a typical patch repair cavity so that the anode assembly body can be covered by the concrete repair material.

Preferably, the remaining dimensions of the anode assembly body are less than 100 mm. This provides an anode assembly of a suitable size for fitting within a typical cavity created for a patch repair. More preferably, the anode assembly body comprises at least one dimension that is less than 40 mm. This size is particularly suitable because 40 mm is a typical depth of cavity required to expose the steel reinforcement closest to the surface of the steel-reinforced concrete structure. It would be understood that the term “dimension” refers to a physical extent.

Preferably, the anode assembly body is attached to the exposed concrete surface using a mechanical fastener. In this way, dislodging of the anode assembly body, which can cause the ionically conductive filler to come into contact with the exposed steel reinforcement, can be avoided. Any suitable mechanical fastener can be used. In one specific example, attaching the anode assembly body to the exposed concrete surface comprises placing a strap over the anode assembly body and securing ends of the strap to the concrete surface. In another example, straps can be positioned on the anode assembly body and the exposed concrete surface and secured in place using an epoxy adhesive.

Preferably, attaching the anode assembly body to the exposed concrete surface comprises attaching a plug to the anode assembly body, creating a hole for the plug in the exposed concrete surface, and inserting the plug into the hole. In this way, the anode assembly can be securely attached to the exposed concrete. The plug can comprise fins configured to resist the removal of the plug from the hole. The plug may be a wall plug.

Preferably, providing a path for electrons to flow from the anode to the exposed steel reinforcement comprises mechanically altering the steel reinforcement to expose inner steel reinforcement that is less corroded than an outer surface of the steel reinforcement and attaching the electron-conducting connector at the exposed inner steel reinforcement. In this way, it can be ensured that the anode assembly makes a good electrical connection with the steel reinforcement, even if the steel reinforcement is rusty or dirty. Mechanically altering the steel reinforcement can comprise drilling, sanding, chipping, or any other suitable technique that can enable attachment of the electron-conducting connector to a less corroded layer of the steel reinforcement.

Preferably, providing a path for electrons to flow from the anode to the exposed steel reinforcement comprises attaching the electron-conducting connector to the exposed steel reinforcement using a mechanical fastener, wherein preferably attaching the electron-conducting connector to the exposed steel reinforcement comprises bolting or riveting the electron-conducting connector to the exposed steel reinforcement. In this way, it can be ensured that the anode assembly makes a good electrical connection with the exposed steel reinforcement, even if the steel reinforcement is rusty or dirty. These techniques may be a particularly convenient way of ensuring a good electrical connection.

Preferably, the method comprises positioning a plurality of anode assemblies within the cavity with the ionically conductive filler between each respective anode assembly body of the plurality of anode assemblies and the exposed concrete surface, attaching each respective assembly body to the exposed concrete surface, and arranging the anode assembly bodies and the ionically conductive filler apart from the exposed steel reinforcement in order to separate the anode assembly bodies and the ionically conductive filler from the exposed steel reinforcement by the concrete repair material. In this way, more of the surrounding steel and concrete can be protected from subsequent corrosion. Each anode assembly of the plurality thereof may be arranged and/or have the properties of the singular anode assembly described above. Preferably, the plurality of anode assemblies comprises at least 3 anode assemblies, preferably at least 6 anode assemblies, most preferably at least 10 anode assemblies.

Preferably, the anode comprises zinc, which is more electrochemically conductive than steel. Alternatively, the anode may comprise aluminium or magnesium, for example.

Preferably, the ionically conductive filler is 2, 3, 5, or 10 times as ionically conductive as the concrete repair material. The skilled person would appreciate that absolute measurements of ionic conductivity of a particular material may depend on the moisture content of the material and the degree to which it has set. The ionically conductive filler may be more ionically conductive than the concrete repair material, optionally by the factors set out above, under installed conditions (i.e., when the ionically conductive filler and concrete repair material have set).

Preferably, the ionically conductive filler comprises a hydrogel or a polymer-modified porous mortar. In other examples, any other suitable material for the ionically conductive filler may be used, as known in the art.

Preferably, the method comprises applying the ionically conductive filler with a thickness of 5 to 20 mm. The specified thickness may be the applied thickness prior to installing the anode assembly in the cavity. In this way, the ionically conductive filler is provided with a thickness that is sufficient to fill crevices in the rough exposed concrete surface to ensure a good electrical connection. The ionically conductive filler may have a thickness of 5 to 20 mm at substantially all parts of the exposed concrete surface where the ionically conductive filler is applied. The anode assembly body is likely to touch the concrete surface at at least one point and usually at least 3 points when it is installed. The ionically conductive filler may be applied to a greater thickness before the anode assembly is installed but drop to within a range of a negligible thickness to about 15 mm when the anode assembly body is pressed onto the exposed concrete surface.

Preferably, the ionically conductive filler is arranged in contact with no more than 80% of the surface area of the anode assembly body, preferably no more than 70%, more preferably no more than 60%, most preferably no more than 50% of the surface area of the anode assembly body. In this way, because the ionically conductive filler is also arranged between the anode assembly body and the exposed concrete, the ionically conductive filler encourages ionic flow away from the cavity, towards the steel reinforcement surrounding the cavity. The ionically conductive filler may be applied substantially to a single continuous area on the exposed concrete surface and/or anode assembly body.

Preferably, the anode assembly body is attached to the exposed concrete surface away from a deepest portion of the cavity with respect to an outer surface of the steel-reinforced concrete structure through which the cavity is formed. This location provides a convenient attachment point that may be easier to reach during installation. More preferably, the anode assembly body is attached to the exposed concrete surface at a depth within the cavity of no more than 80% of a deepest portion of the cavity with respect to an outer surface of the steel-reinforced concrete structure through which the cavity is formed, preferably no more than 70%, more preferably no more than 60%, most preferably no more than 50% of the deepest portion of the cavity.

Preferably, the cavity has a width that is at least twice of a depth of the cavity with respect to an outer surface of the steel-reinforced concrete structure through which the cavity is formed, preferably at least three times the depth, more preferably at least 5 times the depth. In this way, the cavity is of a type typically used to excavate damaged concrete, and therefore does not correspond to a separate cavity in undamaged concrete. Such cavities in undamaged concrete used to install anode assemblies in other approaches are of a minimal width relative to their depth to minimise the removal of sound or damaged concrete.

Preferably, the anode assembly is attached to the exposed concrete surface at a depth within the cavity at which the width of the cavity is at least 3 times, preferably at least 4 times, preferably at least 5 times, the largest dimension of the anode assembly body. Preferably, the anode assembly is attached to the exposed concrete surface at a depth within the cavity at which the width of the cavity is at least 50 cm, preferably at least 60 cm, preferably at least 70 cm, preferably at least 80 cm, preferably at least 90 cm, preferably at least 100 cm. In particular, in contrast with known techniques in which the anode assembly is installed within a cut or drilled hole that is sized specifically for the anode assembly body, in the present method, the anode assembly is being installed in a cavity formed not purposely for the anode assembly, but to remove corrosion-damaged concrete in order to expose the underlying steel reinforcement. These cavities are typically much wider than the anode assembly body.

Preferably, the cavity corresponds to a region of the steel-reinforced concrete structure previously occupied by concrete damaged as a result of corrosion. In this way, the anode assembly is placed in a cavity that has to be made to excavate the damaged concrete, thereby avoiding the creation of a separate cavity configured specifically to receive the anode assembly.

An anode assembly of this invention includes and electrochemically active metal (the anode), a connector attached to the anode and an encapsulating material preferably surrounding the anode. The anode assembly is a discrete anode assembly that is embedded within a reinforced concrete structure.

A cavity or pothole is formed in a steel reinforced concrete structure during repair of damage caused by corrosion of the steel. Concrete is removed back to a sound concrete substrate exposing corroding steel and a new undulating concrete surface (the exposed concrete surface) in the cavity. The peak to trough distance of the undulation perpendicular to the exposed concrete surface may typically exceed 1 mm, or 2 mm, or 3 mm, or 5 mm, or 10 mm, making it difficult to attach anode assemblies to this surface.

In this invention, at least one assembly is attached to the exposed concrete surface using any suitable assembly attachment mechanism. There are preferably at least two anode assemblies attached to the exposed concrete surface and more preferably at least 4 anode assemblies attached to the exposed concrete surface of a single cavity to protect the steel in the concrete extending beyond the cavity on all of its sides. The attachment mechanism is configured to be strong enough to prevent dislodgement of the assembly during a repair process.

The anode assembly is spaced away from the exposed steel in the cavity. In other words, the concrete is removed in a first region, wherein in one part of the first region the steel is exposed and in another part of the first region the underlying steel is not exposed, and the anode is attached where the steel is not exposed.

An ionically conductive filler connects the encapsulating material of the at least one assembly to the exposed concrete surface of the concrete in the cavity. This filler allows ionic current to flow between the encapsulating material and the concrete. The filler may be at least 10 mm thick in places while in other places it may be less than 1 mm thick to accommodate the undulations in the exposed concrete surface.

The ionically conductive filler may also provide an adhesive assembly attachment mechanism. This may, for example, be achieved through use of an ionically conductive filler with adhesive properties. In the alternative, the assembly attachment mechanism may involve pinning the anode to the exposed concrete surface or using a glue to attach the anode to the exposed concrete surface. The assembly attachment mechanism may also include a combination of these alternatives.

The electron-conducting connector of the at least one assembly may be a flexible connector that extends away from the steel. It may be connected to exposed steel in the cavity using any conventional means. This may for example include riveting the connector to the exposed steel using a stainless steel pop rivet. The connector allows electrons to move between the assembly anode and the steel (electronic current).

The remainder of the cavity may be filled with any suitable concrete repair material. This embeds the anode assembly within the cavity and therefore within the repaired structure. The concrete repair material is generally applied to protect the exposed steel in the cavity, restore compressive strength to the structure and/or restore the profile of the reinforced concrete structure. As a consequence, concrete repair materials resist the movement of aggressive ions into the concrete and therefore resist the flow of ionic current in concrete. Once the repair is completed, the anode and encapsulation material of the anode assembly are separated from the exposed steel in the cavity by a layer of the concrete repair material.

Preferably, the encapsulation material is between the ionically conductive filler and the anode. The ionically conductive filler connecting the encapsulation material of the assembly to the exposed concrete surface is more conductive than the repair material that is used to fill the cavity.

This arrangement of the at least one anode assembly promotes the flow of current to the concrete to protect the steel in the concrete adjacent to the area of concrete repair while avoiding the need to form an additional cavity within the sound concrete of the structure. The promotion of current to the steel in the sound concrete of the structure substantially improves the protection of this concrete while limiting the removal of the sound concrete.

### BRIEF DESCRIPTION OF DRAWINGS

Embodiments of the invention are now described, by way of example, with reference to the drawings, in which:

FIG. 1 shows a schematic diagram of a typical discrete embeddable anode assembly;

FIG. 2 shows a schematic diagram of an assembly attachment mechanism to secure an anode assembly to the undulating exposed concrete surface in a cavity or pothole;

FIG. 3 shows a schematic diagram of a combined anode assembly and an assembly attachment mechanism;

FIG. 4 shows a schematic diagram of an example installation of an anode assembly on an undulating exposed concrete surface of a cavity prepared for a concrete repair process;

FIG. 5 shows a schematic diagram of an example installation of an anode assembly on an undulating exposed concrete surface formed in a concrete repair process;

FIG. 6 shows a schematic diagram of an example installation of an anode assembly on an undulating exposed concrete surface formed in a concrete repair process; and

FIG. 7 shows a flowchart of a method of concrete repair according to an embodiment of the invention.

### DETAILED DESCRIPTION

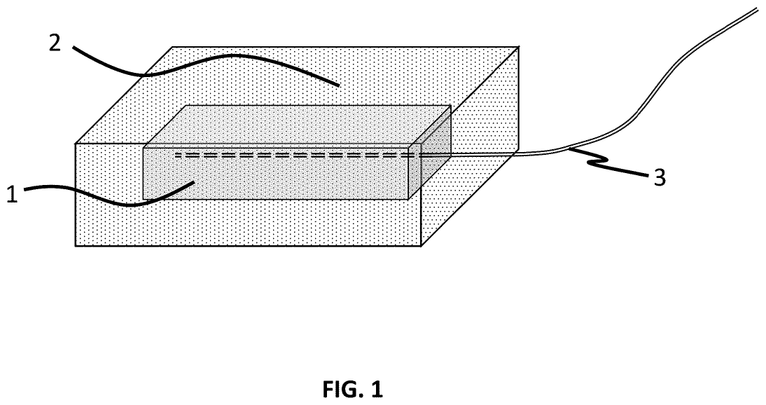

FIG. 1 shows a schematic diagram of an anode assembly suitable for use in the method of the invention. The discrete embeddable anode assembly in the example provided in FIG. 1 includes an assembly anode 1, which can also be referred to as the “anode” of the anode assembly, an encapsulation material 2, and a connector 3. The assembly anode 1 is a more electrochemically active metal than steel and will generally be zinc or a zinc alloy. Other known electrochemically active materials include aluminium, magnesium and alloys thereof. Together, the assembly anode 1 (or “anode”) and the encapsulation material form an anode assembly body.

The encapsulation material 2 is a porous material that retains water and ions. The encapsulation material may, in one example, comprise an electrolyte which in solution has a pH that is sufficiently high for corrosion of the anode to occur and for passive film formation on the anode to be avoided when the anode is galvanically connected to the steel reinforcement. Further examples are provided in WO94/29496 and WO2006/043113. The encapsulation material 2 covers at least one side of the assembly anode 1, but preferably encapsulates the assembly anode on more than one of its sides and even more preferably fully encapsulates the assembly anode 1. The connector 3 is any suitable connector known in the art, such as an uninsulated steel wire. Each anode assembly has at least one connector.

The discrete embeddable anode assembly is sized to fit within a cavity formed at an area subject to concrete repair and more specifically is sized to fit either between reinforcing steel bars exposed in an area of concrete repair or within the concrete cover to the steel bars. The anode assembly may be arranged equidistantly between two or more exposed steel bars (or “rebars”) and may be provided at a periphery of the cavity to better protect nearby enclosed steel reinforcement. The assembly is preferably sized to fit within the concrete cover to the steel bars. The assembly is preferably less than 200 mm in length with its other dimensions being less than 100 mm. The assembly preferably has at least one dimension that is less than 40 mm. This is because 40 mm is the typical thickness of good concrete cover to the nearest layer of steel reinforcement. Specifically, the anode assembly body is sized with the aforementioned dimensions.

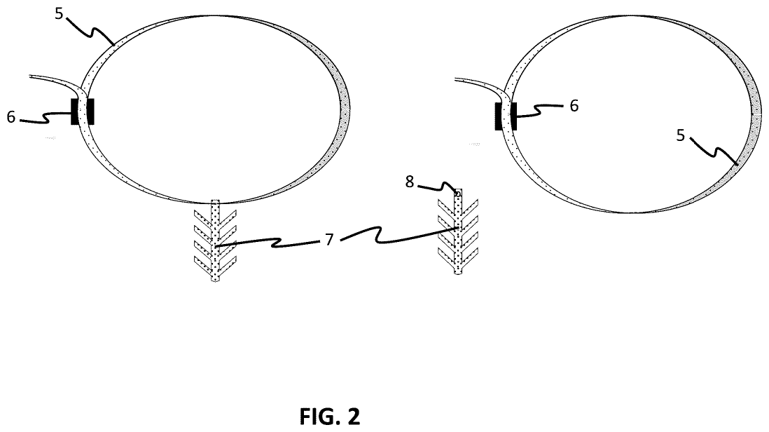

One example of an assembly attachment mechanism to secure an anode assembly to the undulating exposed concrete surface in a cavity or pothole is shown in FIG. 2. The attachment mechanism includes a strap 5 that may be sized to fit the circumference of the anode assembly using a locking mechanism 6. The assembly attachment mechanism includes a finned plug 7 in this example. The plug 7 in this example is attached to the strap 5. This may be via a hole 8 in the plug through which the strap 5 passes. The strap 5 may be a cable tie and the plug may be a wall plug.

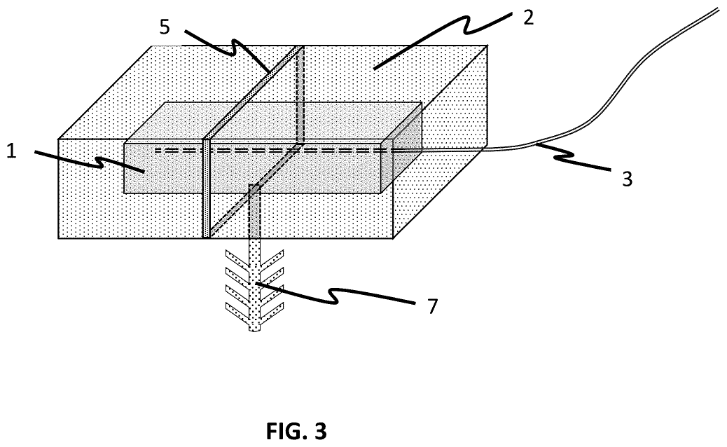

An example of a combined anode assembly and an assembly attachment mechanism is shown in FIG. 3. It includes the assembly anode 1, the assembly encapsulation material 2, the connector 3 connected to the assembly anode 1, a strap 5 and a finned plug 7.

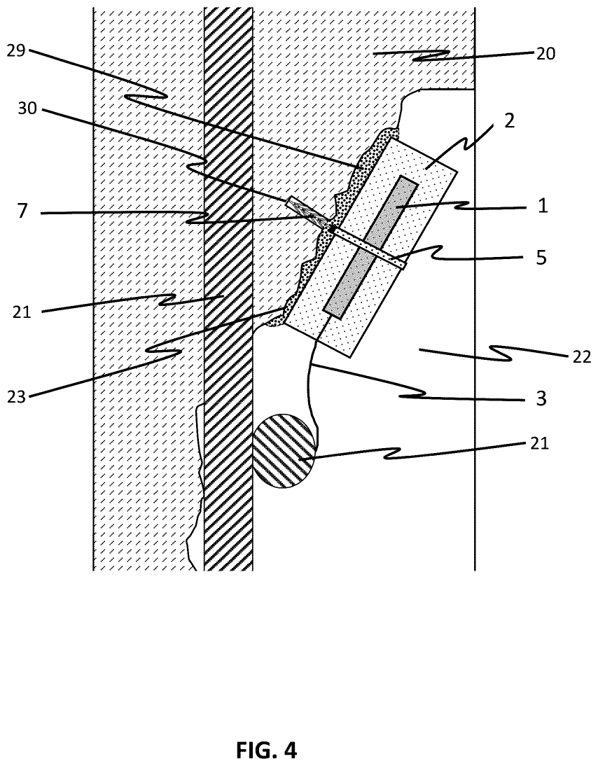

An example of the installation of the anode assembly using the attachment mechanism of FIGS. 2 and 3 is shown in FIG. 4. A reinforced concrete structure includes concrete 20 and reinforcing steel bars 21, which may also be referred to as “steel reinforcement”. At an area of corrosion damage to the structure, a cavity 22 is formed by removing concrete back to sound concrete to expose the corroding steel. This is usually achieved using a high pressure water jet or a jack hammer. The process leaves behind an undulating exposed concrete surface 23 in the cavity 22. The undulation of the exposed concrete surface is likely to have a peak to trough distance perpendicular to the exposed concrete surface of at least 10 mm. When the concrete includes 20 mm aggregate the peak to trough distance may exceed 20 mm.

An anode assembly includes an assembly anode 1, an encapsulation material 2 and a connector 3. The attachment mechanism of this example includes a strap 5 that runs around the assembly anode 1 and the encapsulation material 2, and a plug 7. An ionically conductive filler 29 may also serve the purpose of physically attaching the anode assembly to the exposed concrete surface 23.

In the example in FIG. 4, a hole 30 is drilled into the concrete 20 to accept the plug 7. The hole will typically be between 3 and 10 mm in diameter and preferably be between 5 and 8 mm in diameter. The ionically conductive filler 29 is applied to the base of the anode assembly and/or the exposed concrete surface 23 where the anode is to be positioned. The plug 7 of the attachment mechanism is then pressed into the hole 30. The ionically conductive filler 29 may provide additional physical adhesion between the anode assembly and the exposed concrete surface.

The assembly anode 1 is attached to the steel 21 using the connector 3. The remaining cavity 22 is filled with a concrete repair material (not shown) to protect the exposed steel in the cavity. It may also restore or modify the profile of the reinforced concrete structure.

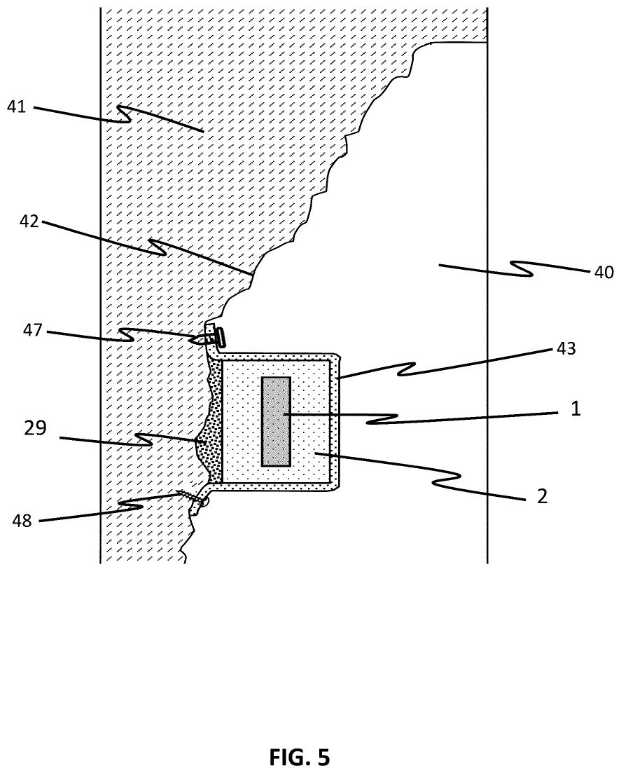

Another example of securing an anode assembly to the undulating exposed concrete surface formed during concrete repair is shown in FIG. 5. A cavity 40 is once again formed in the concrete 41 of a reinforced concrete structure exposing corroding reinforcing steel (not shown). This creates an undulating exposed concrete surface 42. A strap 43 is passed over the assembly anode 1 and assembly encapsulation material 2 of the anode assembly to leave two ends touching the undulating exposed concrete surface 42. A conductive filler 29 fills the gaps between the assembly encapsulation material 2 and the exposed concrete surface 42. The ends of the strap 43 may either be pinned to the exposed concrete surface 42 using a pin 47 or screwed into the exposed concrete surface 42 using a screw 48 to secure the assembly in a place prior to connecting the assembly anode 1 to the reinforcing steel (not shown) and prior to placing the concrete repair material (not shown).

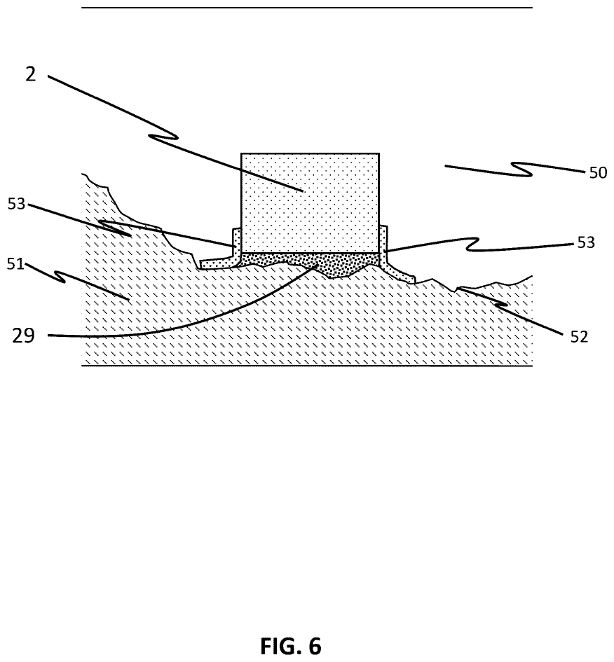

A further example of securing an anode assembly to the undulating exposed concrete surface formed during the concrete repair process is shown in FIG. 6.

A cavity 50 is formed in the concrete 51 of a reinforced concrete structure. This creates an undulating exposed concrete surface 52. Tape 53 is attached to opposite sides of encapsulation material 2 of an anode assembly near to its base, leaving two ends that are attached to the undulating exposed concrete surface 52.

The attachment may be achieved using an adhesive such as an epoxy adhesive used to secure carbon fibre reinforcement to concrete. A conductive filler 29 fills the gaps between the anode assembly and the exposed concrete surface 52. The conductive filler may also act as an adhesive negating the need for the tapes. Such a filler might be an adhesive hydrogel (U.S. Pat. No. 5,650,060) or a polymer modified porous mortar that sets.

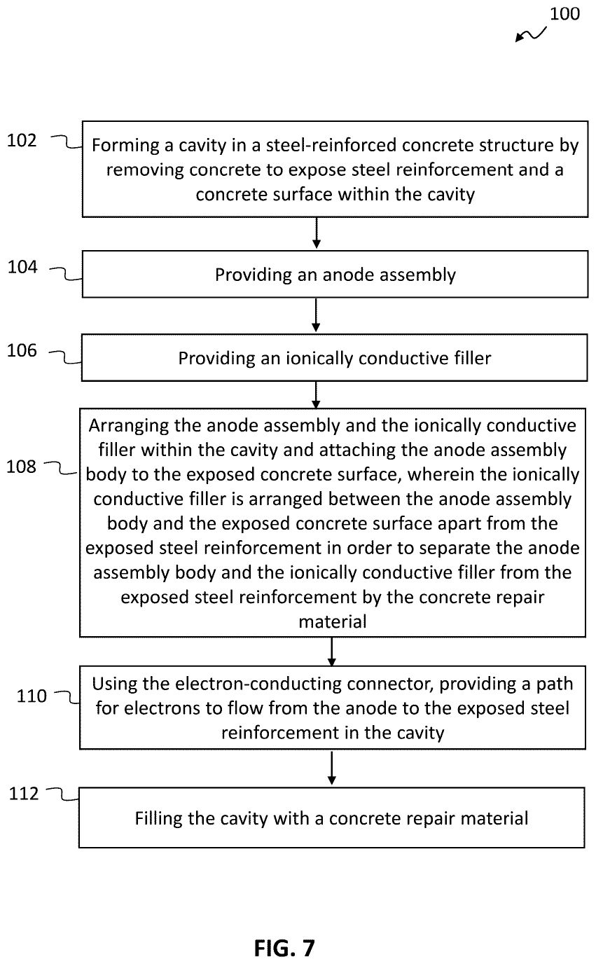

FIG. 7 shows a flowchart of a method 100 of repairing a corrosion-damaged steel-reinforced concrete structure according to an embodiment of the invention. The method 100 can be performed with the apparatus described above with respect to FIGS. 1 to 6.

In step 102, a cavity is formed in a steel-reinforced concrete structure by removing concrete to expose steel reinforcement and a concrete surface within the cavity. The exposed concrete surface may comprise predominantly or only concrete that has not suffered significant corrosion-related damage.

The cavity preferably corresponds to a region of the steel-reinforced concrete that is damaged by corrosion. The anode assembly can be placed in this cavity, such that a separate cavity for the anode assembly is not required to minimise loss of sound concrete. The cavity is preferably wider than it is deep, with respect to a nearest outer surface of the steel-reinforced structure, by at least a factor of 2, 3, 4, or 5. The cavity may be wider than it is deep by a much greater factor than 5 in practice, such as by 10 or 20 times.

In step 104, a suitable anode assembly is provided, such as the anode assembly of FIG. 1. The anode assembly comprises an anode assembly body and an electron-conducting connector, the anode assembly body comprising an anode that is a more electrochemically active metal than the steel reinforcement of the steel-reinforced concrete structure and an encapsulation material adjacent the anode configured to receive a corrosion product produced by the anode. The electron-conducting connector provides a path for electrons to flow from the anode.

In step 106, a suitable ionically conductive filler that has a greater ionic conductivity than the concrete repair material of step 116 is provided.

In step 108, the anode assembly and the ionically conductive filler are arranged within the cavity and the anode assembly body is attached to the exposed concrete surface. The ionically conductive filler is arranged between the anode assembly body and the exposed concrete surface apart from the exposed steel reinforcement in order to separate the anode assembly body and the ionically conductive filler from the exposed steel reinforcement by the concrete repair material in later step 112. The ionically conductive filler is arranged so that it is not in contact with the anode assembly and the exposed steel reinforcement simultaneously, in order to avoid undesirable current flow towards the exposed steel rebar. The anode assembly may be attached to a peripheral region of the cavity for optimal ionic current flow to the surrounding steel.

The ionically conductive filler is preferably applied to the exposed concrete surface before the anode assembly is attached to the exposed concrete surface. In other cases, the ionically conductive filler can be applied to the exposed concrete surface at the same time, for instance by applying the ionically conductive filler initially to the anode assembly so that it becomes applied to the exposed concrete surface when the anode assembly body is attached thereto. In a further alternative, the ionically conductive filler could be injected into gaps between the anode assembly and the exposed concrete surface after attachment of the anode assembly. A combination of these approaches can also be applied.

The ionically conductive filler is ideally provided in a limited area to avoid accidentally forming a connection between the anode assembly body and the exposed steel reinforcement. In one example, the ionically conductive filler is limited to an area of about twice the size of the face of the anode assembly body that faces the exposed concrete surface, once attached.

In some examples, the anode assembly body can be positioned “over” or as near as possible to steel rebar that remains covered by the exposed concrete surface, in order to maximise protective ionic flow to the covered steel rebar. In other words, attaching the anode assembly body to the exposed concrete surface can comprise attaching the anode assembly body to the exposed concrete surface at a portion of the exposed concrete surface that substantially overlaps two steel rebars of the steel-reinforced structure that remain covered by the exposed concrete surface at a position that is equidistant between the two covered steel rebars within a tolerance of 20% of a separation distance between the two covered steel rebars.

In other examples, the anode assembly body may be attached equidistantly between two steel rebars of the exposed steel reinforcement within a tolerance of 20% of a separation distance between the two steel rebars, to distribute current flow between different steel rebars covered by the exposed concrete surface. The anode assembly body may also be located at a periphery of the cavity, at the shallowest regions of the cavity.

In other words, the anode assembly body can be positioned within a “cover zone” as near to the edge of the cavity as possible. The cover zone in a concrete structure is understood to be the zone between a plane touching the surface of the steel nearest the concrete surface and the concrete surface of the finished or repaired concrete structure. The anode assembly body is best located in the cover zone as far as possible from the steel “cage” to improve current distribution.

The anode assembly body is preferably attached to the exposed concrete surface away from a deepest portion of the cavity with respect to an outer surface of the steel-reinforced concrete structure through which the cavity is formed. Alternatively, or in addition, the anode assembly body is preferably attached to the exposed concrete surface at a depth within the cavity of no more than 80% of a deepest portion of the cavity with respect to an outer surface of the steel-reinforced concrete structure through which the cavity is formed, preferably no more than 70%, more preferably no more than 60%, most preferably no more than 50% of the deepest portion of the cavity.

The ionically conductive filler is preferably provided with a thickness sufficient to fill any gaps or crevices in the exposed concrete surface. In one example, the ionically conductive filler may be provided with a thickness of at least 5 to 20 mm.

The ionically conductive filler is preferably limited in application to no more than 80% of the surface area of the anode assembly body, preferably no more than 70%, more preferably no more than 60%, most preferably no more than 50% of the surface area of the anode assembly body.

Optionally, a plurality of anode assemblies can be positioned within the cavity with the ionically conductive filler between each respective anode assembly body of the plurality of anode assemblies and the exposed concrete surface. In this case, each respective assembly body can be attached to the exposed concrete surface, and the anode assembly bodies and the ionically conductive filler can be arranged apart from the exposed steel reinforcement in order to separate the anode assembly bodies and the ionically conductive filler from the exposed steel reinforcement by the concrete repair material.

Where multiple anode assemblies are installed in the cavity, the anode assemblies may be provided at evenly spaced positions around the periphery of the cavity to protect the steel in the concrete surrounding the repair area defined by the cavity. The anode assembly, or assemblies, may be positioned approximately equidistantly between exposed steel bars.

The (or each) anode assembly is attached to the exposed concrete surface using any suitable attachment mechanism or mechanical fastener, such as those described above with respect to FIGS. 4 to 6.

In step 110, a path for electrons to flow is provided from the anode assembly to the exposed steel reinforcement in the cavity using the electron-conducting connector. This can be performed by attaching the connector to the exposed steel reinforcement, or to another electron-conducting connector of another anode assembly arranged in the cavity that is in electrical connection with the exposed steel reinforcement.

The exposed steel reinforcement may be mechanically altered, for instance by drilling, sanding, or scraping, to expose a less corroded part of the steel reinforcement. The electron-conducting connector can then be attached to the less corroded part to ensure a good electrical connection.

Optionally, the connector can be bolted or screwed onto the exposed steel reinforcement to ensure a good electrical connection.

In step 112, the cavity is filled with a concrete repair material. The cavity may be filled sufficiently in order to restore the original profile of the steel-reinforced concrete structure. The concrete repair material provides a barrier between the anode and encapsulation material of the anode assembly so that the anode assembly is only in contact with the previously exposed steel reinforcement by the connector of the anode assembly. This promotes ionic current flow towards the un-corroded steel in the concrete surrounding the repair area to better protect the surrounding steel from subsequent corrosion.

Although the method 100 has been described with respect to a single anode assembly, it would be appreciated that several anode assemblies may be installed in the cavity in a similar manner prior to step 112.

1. A method of repairing corrosion-damaged concrete, comprising;
forming a cavity in a steel-reinforced concrete structure by removing concrete to expose steel reinforcement and a concrete surface within the cavity;
providing an anode assembly, the anode assembly comprising an anode assembly body and an electron-conducting connector, the anode assembly body comprising an anode that is a more electrochemically active metal than the steel reinforcement of the steel-reinforced concrete structure and an encapsulation material adjacent to the anode configured to receive a corrosion product produced by the anode, wherein the electron-conducting connector provides a path for electrons to flow from the anode;
providing an ionically conductive filler;
arranging the anode assembly and the ionically conductive filler within the cavity and attaching the anode assembly body to the exposed concrete surface, wherein the ionically conductive filler is arranged between the anode assembly body and the exposed concrete surface;
using the electron-conducting connector, providing a path for electrons to flow from the anode to the exposed steel reinforcement in the cavity; and
filling the cavity with a concrete repair material;
wherein:
the ionically conductive filler has a greater ionic conductivity than the concrete repair material; and
arranging the anode assembly and the ionically conductive filler within the cavity comprises arranging the anode assembly body and the ionically conductive filler apart from the exposed steel reinforcement in order to separate the anode assembly body and the ionically conductive filler from the exposed steel reinforcement by the concrete repair material.

2. The method of claim 1, wherein the ionically conductive filler is applied to the exposed concrete surface before the anode assembly body is attached to the exposed concrete surface.

3. The method of claim 1, wherein at least some of the ionically conductive filler is applied initially to the anode assembly body such that it becomes applied to the exposed concrete surface with the attachment of the anode assembly body.

4. The method of claim 1, further comprising providing the ionically conductive filler in a localised manner such that a total area of the exposed concrete surface in contact with the ionically conductive filler is less than twice of a total area of a face of the anode assembly body facing the exposed concrete surface.

5. The method of any of claim 1, wherein attaching the anode assembly body comprises attaching the anode assembly body at a peripheral region of the cavity that is shallower than a central region of the cavity with respect to an outer surface of the steel-reinforced concrete structure through which the cavity is formed.

6. The method of any of claim 1, wherein attaching the anode assembly body to the exposed concrete surface comprises attaching the anode assembly body to the exposed concrete surface at a portion of the exposed concrete surface that substantially overlaps two covered steel rebars of the steel-reinforced structure that remain covered by the exposed concrete surface at a position that is equidistant between the two covered steel rebars within a tolerance of 20% of a separation distance between the two covered steel rebars.

7. The method of claim 1, wherein attaching the anode assembly body comprises attaching the anode assembly body equidistantly between two steel rebars of the exposed steel reinforcement within a tolerance of 20% of a separation distance between the two steel rebars.

8. The method of claim 1, wherein the ionically conductive filler is adhesive.

9. The method of claim 1, wherein the anode assembly body has a largest dimension of less than 200 mm.

10. The method of claim 1, wherein the anode assembly body is attached to the exposed concrete surface using a mechanical fastener.

11. The method of claim 1, wherein providing a path for electrons to flow from the anode to the exposed steel reinforcement comprises mechanically altering the steel reinforcement to expose inner steel reinforcement that is less corroded than an outer surface of the steel reinforcement and attaching the electron-conducting connector at the exposed inner steel reinforcement.

12. The method of claim 1, wherein providing a path for electrons to flow from the anode to the exposed steel reinforcement comprises attaching the electron-conducting connector to the exposed steel reinforcement using a mechanical fastener, wherein preferably attaching the electron-conducting connector to the exposed steel reinforcement comprises bolting or riveting the electron-conducting connector to the exposed steel reinforcement.

13. The method of claim 1, further comprising positioning a plurality of anode assemblies within the cavity with the ionically conductive filler between each respective anode assembly body of the plurality of anode assemblies and the exposed concrete surface, attaching each respective assembly body to the exposed concrete surface, and arranging the anode assembly bodies and the ionically conductive filler apart from the exposed steel reinforcement in order to separate the anode assembly bodies and the ionically conductive filler from the exposed steel reinforcement by the concrete repair material.

14. The method of claim 1, wherein the ionically conductive filler is 2, 3, 5, or 10 times as ionically conductive as the concrete repair material.

15. The method of claim 1, comprising applying the ionically conductive filler with a thickness of 5 to 20 mm.

16. The method of claim 1, wherein the ionically conductive filler is arranged in contact with no more than 80% of the surface area of the anode assembly body, preferably no more than 70%, more preferably no more than 60%, most preferably no more than 50% of the surface area of the anode assembly body.

17. The method of claim 1, wherein the anode assembly body is attached to the exposed concrete surface away from a deepest portion of the cavity with respect to an outer surface of the steel-reinforced concrete structure through which the cavity is formed.

18. The method of claim 1, wherein the anode assembly body is attached to the exposed concrete surface at a depth within the cavity of no more than 80% of a deepest portion of the cavity with respect to an outer surface of the steel-reinforced concrete structure through which the cavity is formed, preferably no more than 70%, more preferably no more than 60%, most preferably no more than 50% of the deepest portion of the cavity.

19. The method of claim 1, wherein the cavity has a width that is at least twice of a depth of the cavity with respect to an outer surface of the steel-reinforced concrete structure through which the cavity is formed, preferably at least three times the depth, more preferably at least 5 times the depth.

20. The method of claim 1, wherein the cavity corresponds to a region of the steel-reinforced concrete structure previously occupied by concrete damaged as a result of corrosion.
